(19) United States
(12) Patent Application Publication
(10) Pub. No.: US 2022/0094434 A1
(43) Pub. Date: Mar. 24, 2022

(54) CHARACTERIZING DATA TRANSMITTED OVER AN OPTICAL LINK BASED ON ONE OR MORE WAVELENGTHS USED IN TRANSMISSION

(71) Applicant: Intel Corporation, Santa Clara, CA (US)

(72) Inventors: Dheeraj SUBBAREDDY, Portland, OR (US); Anshuman THAKUR, Beaverton, OR (US); Ankireddy NALAMALPU, Portland, OR (US); MD Altaf HOSSAIN, Portland, OR (US)

(21) Appl. No.: 17/031,820

(22) Filed: Sep. 24, 2020

(51) Int. Cl. H04B 10/079; H04L 29/08; H04L 12/24; H04B 10/25; G06F 9/455

(52) U.S. Cl. CPC H04B 10/07957; H04L 67/1097; H04L 41/5009; G06F 2009/45595; G06F 9/45558; G06F 2009/45583; H04B 10/25

(57) ABSTRACT

Embodiments described herein may be related to apparatuses, processes, and techniques related to characterizing data being transferred from one device to another via an optical link based upon the wavelengths within the optical link on which the data is being carried. In embodiments, the characteristics of this data may include quality of service for the data to be implemented by a field programmable gate array within a heterogeneous storage pool coupled with storage devices, where the quality of service includes minimum threshold values for bandwidth and latency. Other embodiments may be described and/or claimed.

### FIELD

Embodiments of the present disclosure generally relate to the field of semiconductor packaging, and in particular to optical interconnects.

### BACKGROUND

Continued growth in virtual machines and cloud computing will continue to increase the demand for storage device bandwidth and availability.

### BRIEF DESCRIPTION OF THE DRAWINGS

FIG. 1 illustrates an example of data communication between a system-on-a-chip (SOC) and a heterogeneous storage pool over an optical link, in accordance with embodiments.

FIG. 2 illustrates a frequency comb of a laser with equally spaced wavelengths used to transmit data, in accordance with embodiments.

FIG. 3 is a detail of a data communication between a SOC and a heterogeneous storage pool with identified characteristics of the data transmitted over one or more wavelengths, in accordance with embodiments.

FIG. 4 is a detail of a heterogeneous storage pool, in accordance with embodiments.

FIG. 5 is a topology of an SOC in data communication with multiple virtual machines (VMs) and in data communication with a heterogeneous storage pool, in accordance with embodiments.

FIG. 6 is a topology of multiple SOCs in data communication with multiple heterogeneous storage pools, in accordance with embodiments

FIG. 7 illustrates an example of a process to transmit data from a first device to a second device over an optical link where one or more wavelengths over which the data is transmitted identifies characteristics of the data, in accordance with embodiments.

FIG. 8 illustrates an example computing device 800 suitable for use with various components of FIGS. 1-7, in accordance with various embodiments.

FIG. 9 depicts a computer-readable storage medium that may be used in conjunction with the computing device 800, in accordance with various embodiments.

FIG. 10 schematically illustrates a computing device, in accordance with embodiments.

### DETAILED DESCRIPTION

Embodiments described herein may be related to apparatuses, processes, and techniques related to characterizing or identifying characteristics of data being transferred from one device to another via an optical link based upon the wavelengths within the optical link on which the data is being carried. In embodiments, the characteristics of this data may include quality of service (QOS) associated with the data to be used by a field programmable gate array (FPGA) within a heterogeneous storage pool (HSP) coupled with storage devices, where the QOS indicates minimum threshold values for bandwidth and latency. In embodiments, the different wavelengths may be analogous to virtual channels used to carry data having different characteristics.

In particular, these embodiments may be related to a HSP that may be accessed by multiple virtual machines, computing devices, or other computing processes that are interacting with one or more storage devices coupled with the HSP. In embodiments, these multiple virtual machines, computing devices, or other computing processes may each have a QOS for accessing the one or more storage devices. For example, a business entity selling end point storage services to customers may offer different levels of QOS for different subscription amounts per month, depending upon a minimum level of access that the customers may require. There may be many usages of storage applications that require differentiated QOS or differentiated bandwidth access, from real-time process control applications, military applications, or financial applications, to computer system backup storage, or archival storage.

Embodiments described herein may be directed to a package that includes a SOC that receives data from one or more virtual machines or other computing devices, determines the level of QOS for the respective data received, and based upon the QOS level identifies one or more wavelengths onto which the data is to be transferred via an optical link to the HSP. At the HSP, the one or more wavelengths are identified onto which the data was received, and based on those one or more wavelengths, the appropriate QOS level is determined. At that point, the HSP will enforce that QOS level as the data is used to access various storage devices coupled with the HSP. In other embodiments, the one or more wavelengths on which the data was received may indicate to the HSP which of the one or more specific storage devices should be accessed.

In embodiments, the HSP may include application-specific integrated circuits (ASIC) or FPGAs to quickly process the incoming data and various wavelengths on which the data was received. The high-speed ASIC or FPGA may then route the data requests, such as read or write, to the appropriate storage device connected with the HSP, and route the results back to the requesting SOC. In embodiments, the use of optical links provide a very high bandwidth that are very concentrated in terms of space and may be measured, for example, using bandwidth/square millimeter (BW/sq.mm). For example, if an optical connection has a bandwidth of 1 TB, and there are 16 wavelengths carried within the optical fiber strand, that represents 32 GB along each of the 16 wavelengths in the strand. ASICs or FPGAs by their design are able to process this information at this very high bandwidth rate.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

Various Figures herein may depict one or more layers of one or more package assemblies. The layers depicted herein are depicted as examples of relative positions of the layers of the different package assemblies. The layers are depicted for the purposes of explanation, and are not drawn to scale. Therefore, comparative sizes of layers should not be assumed from the Figures, and sizes, thicknesses, or dimensions may be assumed for some embodiments only where specifically indicated or discussed.

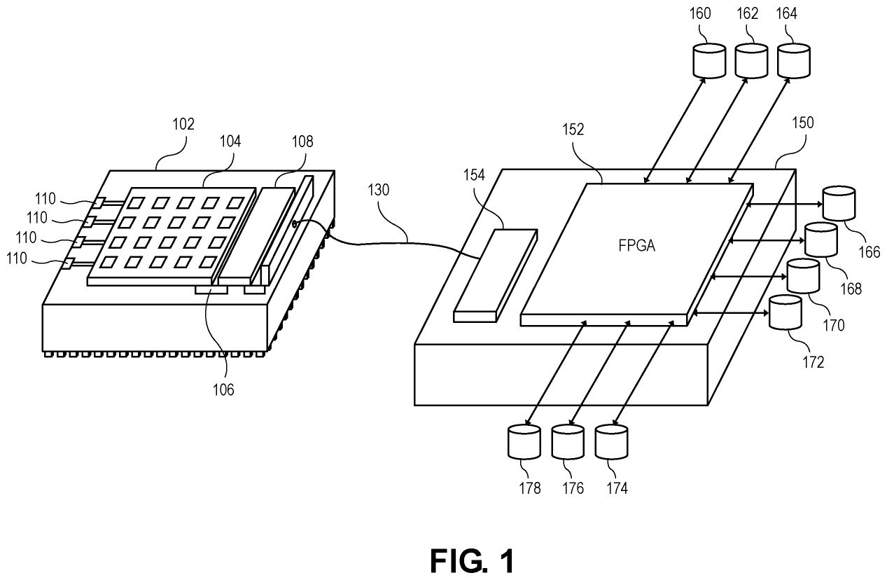

FIG. 1 illustrates an example of data communication between a system-on-a-chip (SOC) and a heterogeneous storage pool over an optical link, in accordance with embodiments. Package 102 includes a SOC 104, that is electrically coupled with an optical tile 108. The SOC 104 may be electrically coupled with the optical tile 108 with an Embedded Multi-die Interconnect Bridge (EMIB) 106. In embodiments, the SOC 104 may be coupled with the optical tile 108 using a silicon interconnect (not shown), or some other interconnect structure.

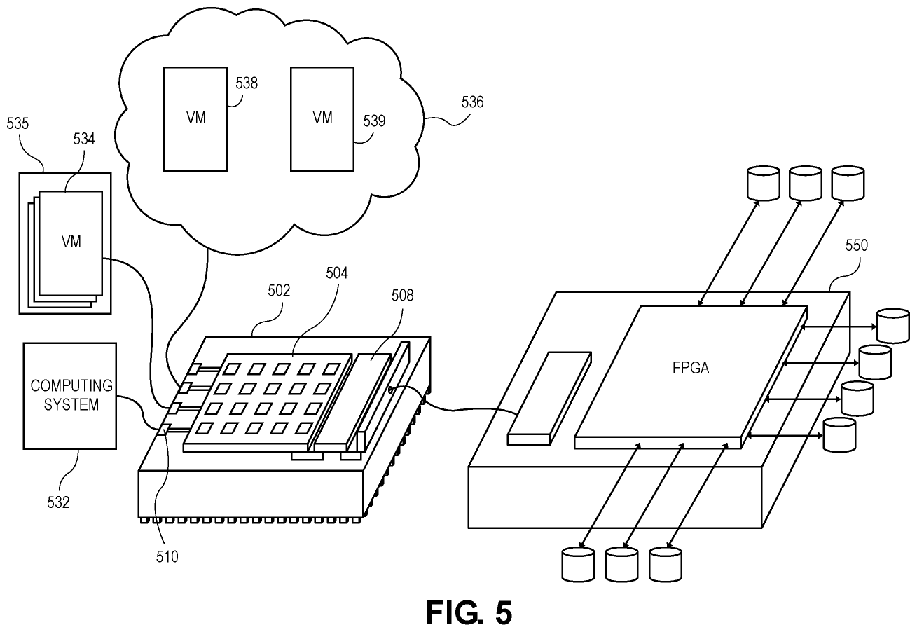

In embodiments, the SOC 104 is coupled with interfaces 110, which may be coupled to one or more compute systems, virtual machines, or other computing processes as described further below with respect to FIG. 5. The interfaces 110 receive and transmit data and/or data requests that are passed between the SOC 104. These data and/or data requests that are received are structured and sent to the optical tile 108, which then converts the data into optical signals to be sent to an HSP 150.

The HSP 150 is a package that includes a FPGA 152 that is coupled with an optical tile 154. In embodiments, the FPGA 152 may be implemented as an ASIC (not shown), or as some other high-speed computer device. The optical tile 154 sends and receives data over an optical fiber 130. The data is then received by the optical tile 154 and is sent to the FPGA 152 which processes the data and/or data requests based upon characteristics of the data and/or data requests received over the optical fiber 130. In embodiments, an optical link that includes the optical tile 108, optical fiber 130, and optical tile 154 may be implemented as a compute express link (CXL) link.

In embodiments, the characteristics of the data and/or data requests may include a particular QOS level associated with the data. In embodiments, the characteristics of the data and/or data requests may be associated with a specific one or more devices that are connected with the HSP 150. For HSP 150, there may be a number of storage devices 160, 162, 164, 166, 168, 170, 172, 174, 176, 178.

In embodiments, the QOS level may correspond with a minimum guaranteed bandwidth or a maximum latency period when interacting with one or more of the storage devices coupled with the HSP 150. In embodiments, the FPGA 152 will enforce the QOS level as the data is used to access various storage devices 160, 162, 164, 166, 168, 170, 172, 174, 176, 178 coupled with the HSP 150. In other embodiments, the optical tile 108 may identify one or more wavelengths over which the data was received via the optical fiber 130. These identified wavelengths, which are now visible to the software stack, may indicate the quality of service level for the data, or which of the one or more specific storage devices 160, 162, 164, 166, 168, 170, 172, 174, 176, 178 the data is associated with. This is discussed in greater detail with respect to FIG. 3 below.

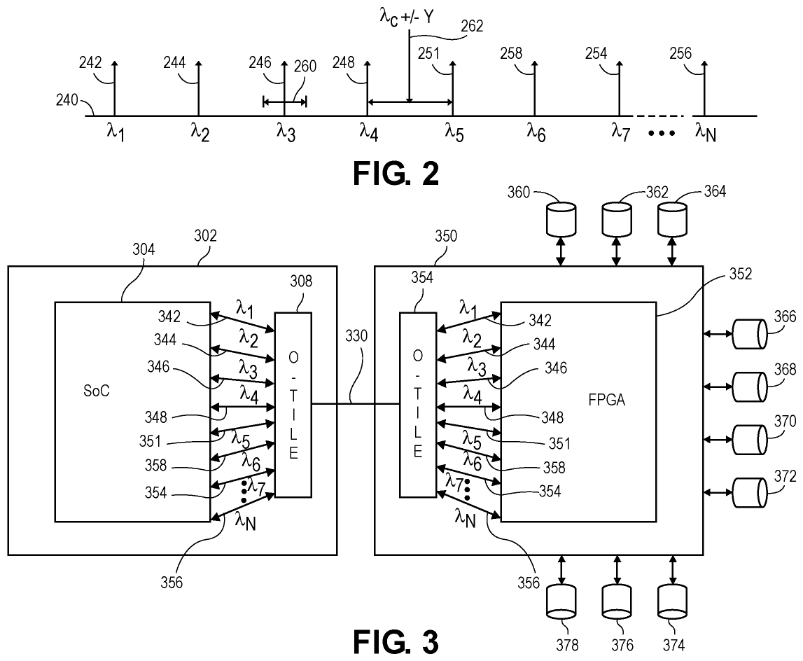

FIG. 2 illustrates an example of a frequency comb of a laser with equally spaced wavelengths used to transmit data, in accordance with embodiments. FIG. 2 shows a wavelength spectrum 240, with N wavelengths 242, 244, 246, 248, 251, 258, 254, 256 along the spectrum 240 that are equally spaced. Each one of these N wavelengths, which may be referred to by the symbol λ, may be used to encode data or portions of data that is sent along the optical fiber 130 of FIG. 1.

In embodiments, each wavelength, for example wavelength 246, may fall within a certain wavelength range 260. A distance between wavelengths, such as wavelength 248 and wavelength 251, may fall within a wavelength range 262, plus or minus a factor Y. Thus, within a wavelength spectrum 240, there are N different wavelengths on which data or portions of data may be multiplexed along optical fiber 130. Note that different embodiments may use different wavelength spacing.

FIG. 3 illustrates a detail of data communication between a SOC and a HSP with identified characteristics of the data transmitted over one or more wavelengths, in accordance with embodiments. FIG. 3 is a schematic that may be similar to FIG. 1. Package 302 may include SOC 304 that is electrically coupled with optical tile 308, which may be similar to package 102, SOC 104, an optical tile 108 of FIG. 1. In embodiments, data may be transmitted to the SOC 304 by way of interfaces 110 (not shown in FIG. 3.) This data may be data and/or data instructions to be implemented by HSP 350, which may be similar to HSP 150 of FIG. 1.

In embodiments, SOC 304 will process the data, including identifying the source of the data, for example a VM described further with respect to FIG. 5, and any characteristics associated with the source of the data. In embodiments, these characteristics may include a particular QOS level associated with the data. In embodiments, these characteristics may identify one or more data devices 360, 362, 364, 366, 368, 370, 372, 374, 376, 378, which may be similar to data devices 160, 162, 164, 166, 168, 170, 172, 174, 176, 178 of FIG. 1. In embodiments, a specific QOS or one or more specific data devices may be a service that customers have available to them or that they may have purchased as part of a subscription.

In embodiments, a quality of service may include a minimum bandwidth level and/or a maximum latency value in terms of access to the data devices. In other embodiments, QOS may apply to the measurement of the overall performance of the service, particularly the performance seen by users of the HSP 350. In embodiments, quality of service may relate to various aspects of network and/or data device service, such as bit rate, throughput, transmission delay, availability, and the like. In embodiments, QOS may relate to traffic prioritization, for example data tagged with a higher QOS getting availability resources the four other data tagged with a lower QOS rating.

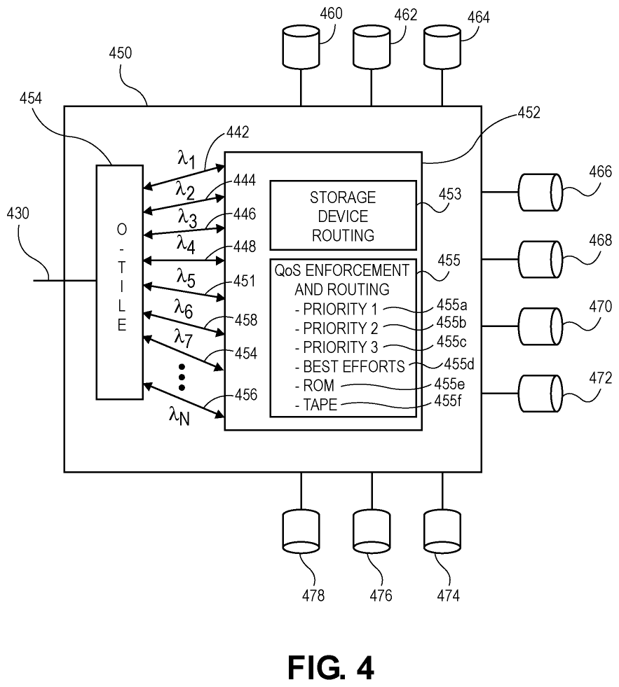

For example, with respect to storage disaggregation, a pool of storage devices 360, 362, 364, 366, 368, 370, 372, 374, 376, 378 connected with and managed by an HSP 350, may be shared by a large number of VM instances on a single physical server as described in greater detail with respect to FIG. 4. Depending on the workload and the VM storage QOS requirements, for example, the data storage I/O requests from these VM instances to the SOC 304 may be tagged with their expected QOS requirements. The transport/interconnect protocols and the end-stage storage system instance, implemented as the HSP 350, will interpret these tags and provide a relative priority to servicing the storage I/O requests. This results in a differentiated QOS for data, such as data storage I/O requests.

Thus, as a result of the identification of these various data characteristics, the SOC 304 in conjunction with the optical tile 308 will select one or more wavelengths 342, 344, 346, 348, 351, 358, 354, 356, which may be similar to wavelengths 242, 244, 246, 248, 251, 258, 254, 256 of FIG. 2, which are associated with the various data characteristics. For example, with respect to QOS, wavelength 342 may be associated with the highest level of priority, for example priority 1, for data associated with accessing storage devices 360, 362 that are coupled with HSP 350. In another example, wavelengths 344, 346 may be used for priority 2 queue requests, and wavelength 356 may be used for the lowest priority, for example data backup or data archiving using storage devices 376, 378 which may be tape-based storage devices having the lowest bandwidth and highest latency. In embodiments, the characteristics of various wavelengths carried on a particular optical link 330 are the same for the SOC 304 and the FPGA 352.

FIG. 4 is a detail of a HSP, in accordance with embodiments. HSP 450 may be similar to HSP 350 of FIG. 3, and HSP 152 of FIG. 1. The optical tile 454 that is connected with an optical fiber 430, which may be similar to optical tile 354 and optical fiber 330 of FIG. 3, send and receive data over wavelengths 442, 444, 446, 448, 451, 458, 454, 456 which may be similar to wavelengths 342, 344, 346, 348, 351, 358, 354, 356 of FIG. 3. The data transmitted over these wavelengths have different characteristics depending upon a particular one or more wavelength over which the data is transmitted, as discussed above.

In embodiments, the FPGA 452, which may be similar to FPGA 352 of FIG. 3, receives data from the optical tile 454 that identifies the one or more wavelengths over which the data was transmitted, and sends this information to the FPGA 452 to identify the characteristics of the data based upon the one or more wavelengths on which the data was carried. In embodiments, data carried on the optical fiber 430 and processed by the optical tile 454 has a high degree of aggregated bandwidth. The FPGA 452 is able to process data at a high rate of speed that is received from this aggregated bandwidth. In embodiments, an FPGA 452, which in other embodiments may be an ASIC, is used as a fan-out to interact with the various storage devices 460, 462, 464, 466, 468, 470, 472, 474, 476, 478, which may be similar to storage devices 360, 362, 364, 366, 368, 370, 372, 374, 376, 378 of FIG. 3.

In embodiments, the FPGA 452 may be well-suited because storage technologies associated with the storage devices, use different I/O standards and bandwidths depending upon the cost per performance-byte trade-offs. Additionally, an FPGA may be ideally suited to implement a differentiated dataflow engine.

In embodiments, the FPGA 452 may implement storage device routing 453, and/or QOS enforcement and routing 455. With respect to storage device routing 453, the FPGA 452 will identify data coming over specific wavelengths, for example wavelengths 444, 446, and identify that data over those wavelengths is associated with one or more specific storage devices, for example storage devices 460, 462. In embodiments, data received or transmitted over those wavelengths 444, 446 may be uniquely assigned to the storage devices 460, 462 and vice versa. In other embodiments, data received or transmitted over those wavelengths 444, 446 may be nonexclusively associated with a range of storage devices, for example storage devices 466, 468, 470, that may be shared with other data sources such as VMs as discussed below with respect to FIG. 5.

With respect to QOS enforcement and routing 455, the FPGA 452 will identify data coming in over specific wavelengths, for example wavelengths 451, 458, and assure that data is associated with a particular QOS associated with the data. The QOS, for example, may assure a minimum amount of bandwidth, or a maximum amount of latency for data received and processed by the HSP 450. QOS enforcement and routing 455 may manage a variety of queues 455a, 455b, 455c, 455d, 455e, 455f, each having a different level of QOS (e.g. bandwidth and latency) that is enforced. In embodiments, these queues may be associated with one or more specific storage devices 460, 462, 464, 466, 468, 470, 472, 474, 476, 478.

For example, queue 455a may be a priority 1 queue that has the highest level of bandwidth and responsiveness available on the HSP 450, and may be used for mission-critical applications running on computing systems or VMs that have to do with life or death situations, for example 911 operations, or other extremely urgent matters. Queue 455b may be a priority 2 queue that has a second highest level of QOS that may be used for financial transactions or real-time operations such as electronic ticket taking and validation services for a nationwide transportation system. Queue 455c may be a priority 3 queue that has a third highest level of QOS that may be used for less critical but still important applications such as updating news or non-critical financial data.

Queue 455d may provide a best-efforts queue, which may be a lower priority queue with lower acceptable bandwidth and higher acceptable latency thresholds which will have data processed in it after the higher priority queues have been processed. Queues 455e, 455f may be, respectively, a read-only memory (ROM) queue or a tape queue that may be used for backing up, archiving, or preserving data. These queues may have the lowest priority and quality of service, and may be scheduled at specific times when the HSP 450 has a lighter workload.

FIG. 5 is a topology of an SOC in data communication with multiple virtual machines (VMs) and in data communication with a heterogeneous storage pool, in accordance with embodiments. FIG. 5 includes package 502 that includes an SOC 504 electrically coupled with an optical tile 508 and with interfaces 510. These may be similar to package 102 that included an SOC 104 electrically coupled with the optical tile 108 and with interfaces 110 of FIG. 1.

In embodiments, data may be received through interfaces 510 from a variety of sources, including one or more computing systems 532 that may be physically coupled with the package 502. In addition, data sources may include, various virtual machines 534 running on one or more systems 535 that may be remotely coupled with the package 502 and SOC 504. This example may be relevant to an enterprise-based solution for providing endpoint storage, that may include enterprise-level subscriptions to endpoint storage. In other embodiments, the data may be received from cloud-based 536 virtual machines 538, 539 that are coupled with the SOC 504 via the interface 510. This example may be relevant to providing a cloud-based service to provide endpoint storage, that may include various subscription levels that correspond to various QOS levels.

For example, the owners of these systems 532, 535 and/or VMs 534, 538, 539 may have engaged in a contractual agreement with the provider of the storage service endpoint, for example HSP 550, which may be similar to HSP 450 of FIG. 4. This contractual agreement may specify various QOS levels for data interactions to which the SOC 504 and the HSP 550 must adhere, and be enforced by the FPGA 452 as described with respect to embodiments described in FIG. 4. In embodiments, FIG. 5 may be implemented as a volume management device (VIVID)-like storage abstraction, using various nonvolatile memory express (NVMe) controller interface and storage protocol.

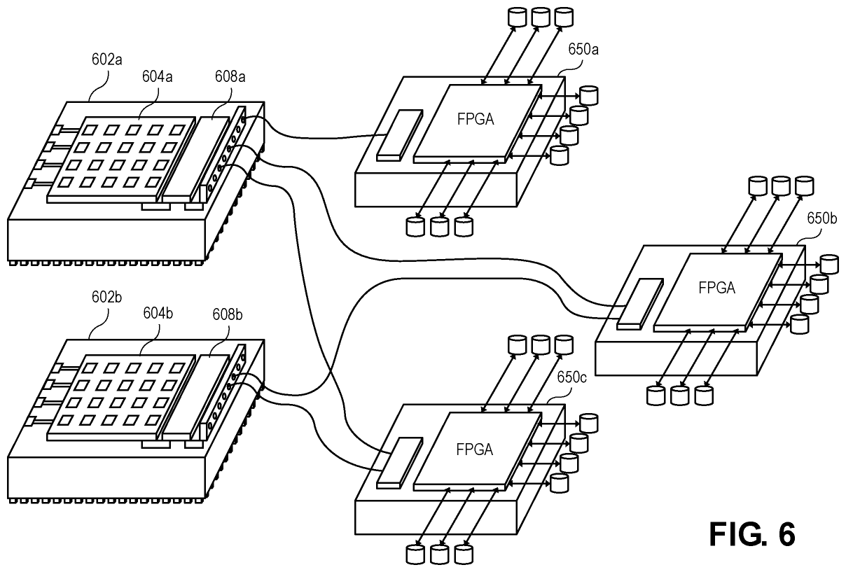

FIG. 6 is a topology of multiple SOCs in data communication with multiple heterogeneous storage pools, in accordance with embodiments. FIG. 6 shows multiple packages 602a, 602b, including, respectively SOC 604a, 604b coupled with optical tile 608a, 608b. The multiple packages 602a, 602b may be optically coupled with multiple HSPs 650a, 650b, 650c in a variety of configurations. These may be similar to package 102 that includes SOC 104 and optical tile 108, in conjunction with HSP 150 of FIG. 1.

For example, in one embodiment package 602a may be optically coupled with HSPs 650a, 650b, 650c. In another embodiment, package 602b may be only optically coupled with HSPs 650b, 650c. In other embodiments (not shown) a package 602a may have multiple optical connections with an HSP 650a that includes a plurality of optical tiles included in a package that are optically coupled with various FPGAs within HSPs that also include multiple optical tiles. In embodiments, the high optical bandwidth provided by optical connections between the SOCs 604a, 604b, may be used to provide access to storage devices supported by multiple HSPs in greater than a 1 to 1 ratio.

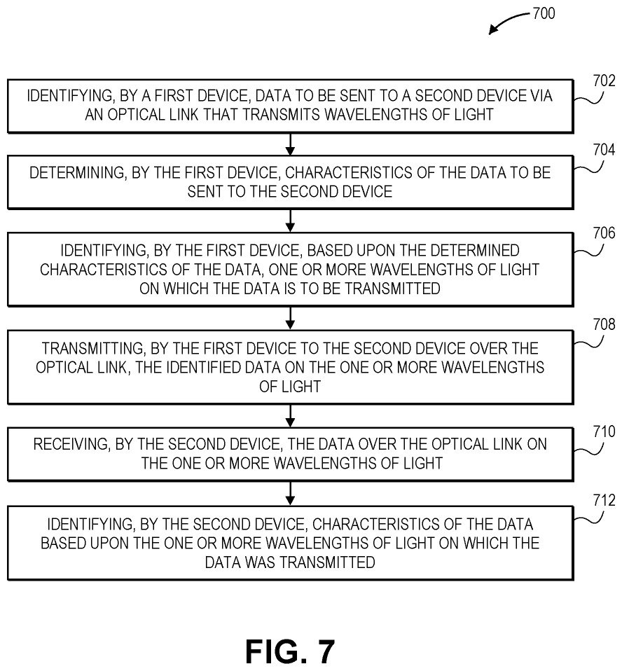

FIG. 7 illustrates an example of a process to transmit data from a first device to a second device over an optical link where one or more wavelengths over which the data is transmitted identifies characteristics of the data, in accordance with embodiments. Process 700 may be performed by one or more processes, techniques, apparatus, described herein and particularly with respect to FIGS. 1-6.

At block 702, the process may include identifying, by a first device, data to be sent to a second device via an optical link that transmits wavelengths of light. In embodiments, the first device may be similar to the package 102 that includes the SOC 104 electrically coupled to the optical tile 108 of FIG. 1, the package 302 that includes the SOC 304 electrically coupled to the optical tile 308 of FIG. 3, the package 502 that includes the SOC 504 electrically coupled to the optical tile 508 of FIG. 5, and/or the package 602a that includes the SOC 604a that is electrically coupled to the optical tile 608a or the package 602b that includes the SOC 604b that is electrically coupled to the optical tile 608b of FIG. 6.

In embodiments, the second device may be similar to the HSP 152 of FIG. 1, the HSP 350 of FIG. 3, the HSP 450 of FIG. 4, the HSP 550 of FIG. 5, or the HSPs 650a, 650b, 650c of FIG. 6. In embodiments, the optical link may include optical link 130 of FIG. 1 or optical link 330 of FIG. 3.

At block 704, the process may further include determining, by the first device, characteristics of the data to be sent to the second device. In embodiments, the determining may be performed by one or more of the SOC 304 and the optical tile 308 of FIG. 3 based upon data received through interface 110 of FIG. 1. In embodiments, a source of the data may include characteristics of the data, which may include an identified QOS associated with the source of the data, for example a VM.

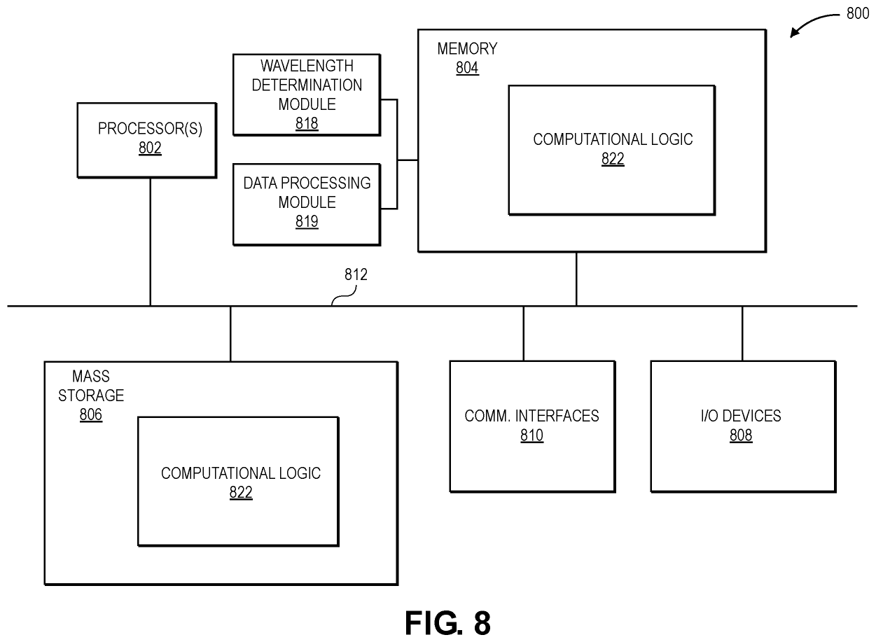

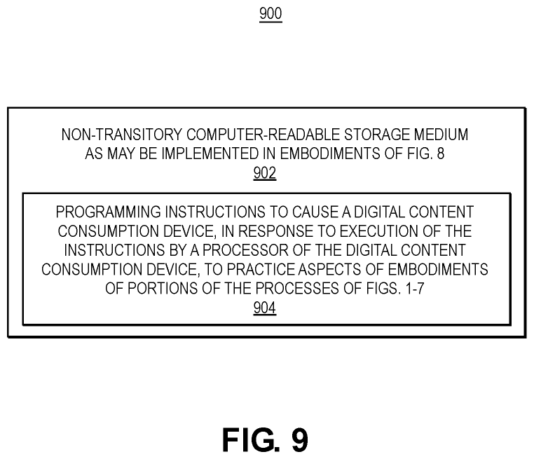

At block 706, the process may further include identifying, by the first device, based upon the determined characteristics of the data, one or more wavelengths of light on which the data is to be transmitted. In embodiments, identifying one or more wavelengths may be similar to the process described with respect to SOC 104 of FIG. 1 and/or SOC 304 of FIG. 3. In embodiments, the characteristics will map to one or more wavelengths that may be transmitted by optical tile 308 of FIG. 3. In embodiments, this portion of the process be performed by the wavelength determination module 818 of FIG. 8.

At block 708, the process may further include transmitting, by the first device to the second device over the optical link, the identified data on the one or more wavelengths of light. In embodiments, this may be performed by the optical tile 308 coupled to SOC 304 over optical link 330 of FIG. 3.

At block 710, the process may further include receiving, by the second device, the data over the optical link on the one or more wavelengths of light. In embodiments, this may be performed by the link 330 coupled with the optical tile 354 that is electrically coupled with the FPGA 352 of HSP 350 of FIG. 3

At block 712, the process may further include identifying, by the second device, characteristics of the data based upon the one or more wavelengths of light on which the data was transmitted. In embodiments, this may be performed by the FPGA 352 included in HSP 350 of FIG. 3. In embodiments, this portion of the process may be performed by a wavelength determination module 818 or the data processing module 819 of FIG. 8.

Other process embodiments may include determining, based upon the characteristics of the data, one or more QOS levels that are enforced by an FPGA, such as FPGA 352, when processing the data associated with one or more storage devices. In embodiments, the storage devices may include storage devices 360, 362, 364, 366, 368, 370, 372, 374, 376, 378 of FIG. 3.

FIG. 8 illustrates an example computing device 800 suitable for use with various components of FIGS. 1-7, in accordance with various embodiments. As shown, computing device 800 may include one or more processors or processor cores 802 and system memory 804. For the purpose of this application, including the claims, the terms “processor” and “processor cores” may be considered synonymous, unless the context clearly requires otherwise. The processor 802 may include any type of processors, a microprocessor, and the like. The processor 802 may be implemented as an integrated circuit having multi-cores, e.g., a multi-core microprocessor.

The computing device 800 may include mass storage devices 806 (such as diskette, hard drive, volatile memory (e.g., dynamic random-access memory (DRAM), compact disc read-only memory (CD-ROM), digital versatile disk (DVD), and so forth). In general, system memory 804 and/or mass storage devices 806 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory. Non-volatile memory may include, but is not limited to, electrically erasable programmable read-only memory, phase change memory, resistive memory, and so forth.

The computing device 800 may further include I/O devices 808 (such as a display (e.g., a touchscreen display)), keyboard, cursor control, remote control, gaming controller, image capture device, a camera, one or more sensors, and so forth) and communication interfaces 810 (such as network interface cards, serial buses, modems, infrared receivers, radio receivers (e.g., Bluetooth), and so forth).

The communication interfaces 810 may include communication chips (not shown) that may be configured to operate the computing device 800 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond.

The above-described computing device 800 elements may be coupled to each other via system bus 812, which may represent one or more buses, and which may include, for example, PCIe buses. In other words, all or selected ones of processors 802, memory 804, mass storage 806, communication interfaces 810 and I/O devices 808 may be PCIe devices or other serial bus-based devices. In particular, they may be PCIe devices incorporated with the teachings of the present disclosure to enable detection of silent data corruption. In the case of multiple buses, they may be bridged by one or more bus bridges (not shown). Each of these elements may perform its conventional functions known in the art. In particular, system memory 804 and mass storage devices 806 may be employed to store a working copy and a permanent copy of the programming instructions for the operation of various components of computing device 800, including but not limited to an operating system of computing device 800, one or more applications, and/or system software/firmware in support of practice of the present disclosure, collectively referred to as computing logic 822, having wavelength determination module 818 and data processing module 819. The various elements may be implemented by assembler instructions supported by processor(s) 802 or high-level languages that may be compiled into such instructions.

The permanent copy of the programming instructions may be placed into mass storage devices 806 in the factory, or in the field through, for example, a distribution medium (not shown), such as a compact disc (CD), or through communication interface 810 (from a distribution server (not shown)). That is, one or more distribution media having an implementation of the agent program may be employed to distribute the agent and to program various computing devices.

The number, capability, and/or capacity of the elements 802, 804, 806, 808, 810, and 812 may vary, depending on whether computing device 800 is used as a stationary computing device, such as a set-top box or desktop computer, or a mobile computing device, such as a tablet computing device, laptop computer, game console, or smartphone. Their constitutions are otherwise known, and accordingly will not be further described.

In embodiments, at least one of processors 802 may be packaged together with computational logic 822 configured to practice aspects of embodiments described herein to form a System in Package (SiP) or a System on Chip (SOC).

In various implementations, the computing device 800 may be one or more components of a data center, a laptop, a netbook, a notebook, an ultrabook, a smartphone, a tablet, a personal digital assistant (PDA), an ultra mobile PC, a mobile phone, a digital camera, or an IoT user equipment. In further implementations, the computing device 800 may be any other electronic device that processes data.

FIG. 9 depicts a computer-readable storage medium that may be used in conjunction with the computing device 800, in accordance with various embodiments. Diagram 900 illustrates an example non-transitory computer-readable storage media 902 having instructions configured to practice all or selected ones of the operations associated with the processes described above in FIG. 8. As illustrated, non-transitory computer-readable storage medium 902 may include a number of programming instructions 804 from FIG. 8 (e.g., including wavelength determination module 818 and data processing module 819). Programming instructions 904 may be configured to enable a device, e.g., computing device 800, in response to execution of the programming instructions, to perform one or more operations of the processes described in reference to FIGS. 1-7. In alternate embodiments, programming instructions 904 may be disposed on multiple non-transitory computer-readable storage media 902 instead. In still other embodiments, programming instructions 904 may be encoded in transitory computer-readable signals.

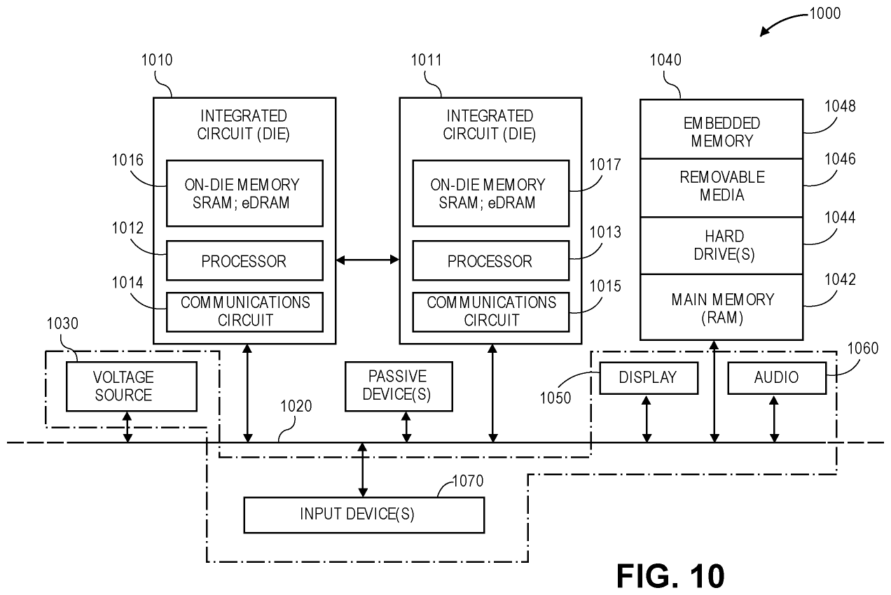

FIG. 10 is a computer system 1000 (also referred to as the electronic system 1000) as depicted that can embody all or part of characterizing data transmitted over an optical link based on one or more wavelengths used in transmission, according to any of the several disclosed embodiments and their equivalents as set forth in this disclosure. The computer system 1000 may be a mobile device such as a netbook computer. The computer system 1000 may be a mobile device such as a wireless smart phone. The computer system 1000 may be a desktop computer. The computer system 1000 may be a hand-held reader. The computer system 1000 may be a server system. The computer system 1000 may be a supercomputer or high-performance computing system.

In an embodiment, the electronic system 1000 is a computer system that includes a system bus 1020 to electrically couple the various components of the electronic system 1000. The system bus 1020 is a single bus or any combination of busses according to various embodiments. The electronic system 1000 includes a voltage source 1030 that provides power to the integrated circuit 1010. In some embodiments, the voltage source 1030 supplies current to the integrated circuit 1010 through the system bus 1020.

The integrated circuit 1010 is electrically coupled to the system bus 1020 and includes any circuit, or combination of circuits according to an embodiment. In an embodiment, the integrated circuit 1010 includes a processor 1012 that can be of any type. As used herein, the processor 1012 may mean any type of circuit such as, but not limited to, a microprocessor, a microcontroller, a graphics processor, a digital signal processor, or another processor. In an embodiment, the processor 1012 includes, or is coupled with, all or part of characterizing data transmitted over an optical link based on one or more wavelengths used in transmission, as disclosed herein. In an embodiment, SRAM embodiments are found in memory caches of the processor. Other types of circuits that can be included in the integrated circuit 1010 are a custom circuit or an application-specific integrated circuit (ASIC), such as a communications circuit 1014 for use in wireless devices such as cellular telephones, smart phones, pagers, portable computers, two-way radios, and similar electronic systems, or a communications circuit for servers. In an embodiment, the integrated circuit 1010 includes on-die memory 1016 such as static random-access memory (SRAM). In an embodiment, the integrated circuit 1010 includes embedded on-die memory 1016 such as embedded dynamic random-access memory (eDRAM).

In an embodiment, the integrated circuit 1010 is complemented with a subsequent integrated circuit 1011. Useful embodiments include a dual processor 1013 and a dual communications circuit 1015 and dual on-die memory 1017 such as SRAM. In an embodiment, the dual integrated circuit 1010 includes embedded on-die memory 1017 such as eDRAM.

In an embodiment, the electronic system 1000 also includes an external memory 1040 that in turn may include one or more memory elements suitable to the particular application, such as a main memory 1042 in the form of RAM, one or more hard drives 1044, and/or one or more drives that handle removable media 1046, such as diskettes, compact disks (CDs), digital variable disks (DVDs), flash memory drives, and other removable media known in the art. The external memory 1040 may also be embedded memory 1048 such as the first die in a die stack, according to an embodiment.

In an embodiment, the electronic system 1000 also includes a display device 1050, an audio output 1060. In an embodiment, the electronic system 1000 includes an input device such as a controller 1070 that may be a keyboard, mouse, trackball, game controller, microphone, voice-recognition device, or any other input device that inputs information into the electronic system 1000. In an embodiment, an input device 1070 is a camera. In an embodiment, an input device 1070 is a digital sound recorder. In an embodiment, an input device 1070 is a camera and a digital sound recorder.

As shown herein, the integrated circuit 1010 can be implemented in a number of different embodiments, including all or part of characterizing of data transmitted over an optical link based on one or more wavelengths used in transmission, according to any of the several disclosed embodiments and their equivalents, an electronic system, a computer system, one or more methods of fabricating an integrated circuit, and one or more methods of fabricating an electronic assembly that includes a package substrate implementing all or part of characterizing data transmitted over an optical link based on one or more wavelengths used in transmission, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed processes used for characterizing data transmitted over an optical link based on one or more wavelengths used in transmission embodiments and their equivalents. A foundation substrate may be included, as represented by the dashed line of FIG. 10. Passive devices may also be included, as is also depicted in FIG. 10.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

The following paragraphs describe examples of various embodiments.

### EXAMPLES

Example 1 is an apparatus comprising: one or more computer processors; a wavelength determination module, communicatively coupled with the one or more processors, wherein the wavelength determination module is to: identify data to be sent to another apparatus via an optical link that transmits and receives multiple wavelengths of light; determine characteristics of the data to be sent to the other apparatus; identify, based upon the determined characteristics of the data, one or more wavelengths of light over which the data is to be transmitted; and a transmission module, communicatively coupled with the one or more computer processors, wherein the transmission module is to transmit the identified data to the other apparatus over the optical link using the identified one or more wavelengths of light; and wherein the other apparatus, upon receipt of the data, is to identify the characteristics of the data based upon the one or more wavelengths of light on which the data was received.

Example 2 may include the apparatus of example 1, wherein the characteristics of the data include a selected one of: a quality of service for the data, a priority for the data, or an identification of a storage service for the data.

Example 3 may include the apparatus of example 2, wherein determine characteristics of the data to be sent to the other apparatus further includes: identify a source of the data; and determine characteristics of the data based in part on the identified source of the data.

Example 4 may include the apparatus of example 3, wherein the source of the data is one or more virtual machines (VM) that are communicatively coupled with the apparatus.

Example 5 may include the apparatus of example 4, wherein the one or more VMs operate in a cloud.

Example 6 may include the apparatus of example 4, wherein the one or more VMs are coupled with the apparatus using Non-Volatile Memory Express (NVMe).

Example 7 may include the apparatus of example 4, wherein the characteristics of the data for one of the one or more VMs includes a quality of service for which the one of the one or more VMs is subscribed.

Example 8 may include the apparatus of example 2, wherein the identification of a storage service for the data further includes one or more storage devices coupled with the other apparatus, wherein the one or more storage devices are associated with the one or more wavelengths of light.

Example 9 may include the apparatus of any one of examples 1-8, wherein the transmission module is to transmit the identified data via an optical tile (O-tile).

Example 10 may include the apparatus of example 1, wherein the other apparatus further includes multiple other apparatuses.

Example 11 may be an apparatus comprising: one or more computer processors; a wavelength determination module, communicatively coupled with the one or more computer processors, wherein the wavelength determination module is to: receive data from another apparatus via one or more wavelengths via an optical link that transmits and receives multiple wavelengths of light; and determine characteristics of the data based upon the one or more wavelengths of light over the optical link on which the data was received; a data processing module, communicatively coupled with the one or more computer processors, wherein the data processing module is to process the received data based upon the determined characteristics of the data.

Example 12 may include the apparatus of example 11, wherein the characteristics of the data include a selected one of: a quality of service for the data, a priority for the data, or an identification of one or more storage devices for the data.

Example 13 may include the apparatus of example 11, wherein the data processing module is communicatively coupled with one or more storage devices, wherein the one or more storage devices are associated with one or more wavelengths of light of the optical link.

Example 14 may include the apparatus of example 12, wherein the data is processed at a responsiveness level based upon the quality of service for the data.

Example 15 may include the apparatus of example 14, wherein the responsiveness level is associated with a minimum bandwidth value or a maximum latency value.

Example 16 may include the apparatus of example 11, wherein the other apparatus further comprises multiple other apparatuses; and wherein the optical link includes multiple optical links.

Example 17 may include the apparatus of example 11, wherein the apparatus is a storage endpoint device.

Example 18 may include the apparatus of any one of examples 11-17, wherein the apparatus is at least partially implemented with an application-specific integrated circuit (ASIC) or a field programmable gate array (FPGA).

Example 19 may be a method comprising: identifying, by a first device, data to be sent to a second device via an optical link that transmits wavelengths of light; determining, by the first device, characteristics of the data to be sent to the second device; identifying, by the first device, based upon the determined characteristics of the data, one or more wavelengths of light on which the data is to be transmitted; transmitting, by the first device to the second device over the optical link, the identified data on the one or more wavelengths of light; receiving, by the second device, the data over the optical link on the one or more wavelengths of light; identifying, by the second device, characteristics of the data based upon the one or more wavelengths of light on which the data was transmitted.

Example 20 may include the method of example 19, further including processing, by the second device, the received data based upon the identified characteristics of the data.

Example 21 may include the method of any one of examples 19-20, wherein characteristics of the data identify a class of service for the data or identify one or more storage devices coupled with the second device associated with the data.

Example 22 may be a system, comprising: an optical link; a first device coupled with the optical link, the first device to: identify data to be sent to a second device via an optical link that transmits wavelengths of light; determine characteristics of the data to be sent to the second device; identify, based upon the determined characteristics of the data, one or more wavelengths of light on which the data is to be transmitted to the second device; and transmit the identified data to the second device over the optical link using the one or more wavelengths of light, wherein the second device, upon receipt of the data, is to identify the characteristics of the data based upon the one or more wavelengths of light over which the data was transmitted; the second device coupled to the optical link, the second device to: receive data from the first device via the one or more wavelengths via the optical link; determine characteristics of the received data based upon the one or more wavelengths of light; and process the received data based upon the determined characteristics of the received data.

Example 23 may include the system of example 22, further comprising: a plurality of storage devices coupled with the second device; and wherein to process the received data further includes: to read and/or write data related to the received data from and/or to one or more of the plurality of storage devices based on the determined characteristics of the received data.

Example 24 may include the system of example 23, wherein the determined characteristics of the received data includes an indication of a quality of service for the received data.

Example 25 may include the system of any one of examples 22-24, wherein the indication of the quality of service further includes an indication of a minimum bandwidth value and/or a maximum latency time for reading and/or writing data.

What is claimed is:

1. An apparatus comprising:
one or more computer processors;
a wavelength determination module, communicatively coupled with the one or more processors, wherein the wavelength determination module is to:
identify data to be sent to another apparatus via an optical link that transmits and receives multiple wavelengths of light;
determine characteristics of the data to be sent to the other apparatus;
identify, based upon the determined characteristics of the data, one or more wavelengths of light over which the data is to be transmitted; and
a transmission module, communicatively coupled with the one or more computer processors, wherein the transmission module is to transmit the identified data to the other apparatus over the optical link using the identified one or more wavelengths of light; and
wherein the other apparatus, upon receipt of the data, is to identify the characteristics of the data based upon the one or more wavelengths of light on which the data was received.

2. The apparatus of claim 1, wherein the characteristics of the data include a selected one of: a quality of service for the data, a priority for the data, or an identification of a storage service for the data.

3. The apparatus of claim 2, wherein determine characteristics of the data to be sent to the other apparatus further includes:
identify a source of the data; and
determine characteristics of the data based in part on the identified source of the data.

4. The apparatus of claim 3, wherein the source of the data is one or more virtual machines (VM) that are communicatively coupled with the apparatus.

5. The apparatus of claim 4, wherein the one or more VMs operate in a cloud.

6. The apparatus of claim 4, wherein the one or more VMs are coupled with the apparatus using Non-Volatile Memory Express (NVMe).

7. The apparatus of claim 4, wherein the characteristics of the data for one of the one or more VMs includes a quality of service for which the one of the one or more VMs is subscribed.

8. The apparatus of claim 2, wherein the identification of a storage service for the data further includes one or more storage devices coupled with the other apparatus, wherein the one or more storage devices are associated with the one or more wavelengths of light.

9. The apparatus of claim 1, wherein the transmission module is to transmit the identified data via an optical tile (O-tile).

10. The apparatus of claim 1, wherein the other apparatus further includes multiple other apparatuses.

11. An apparatus comprising:
one or more computer processors;
a wavelength determination module, communicatively coupled with the one or more computer processors, wherein the wavelength determination module is to:
receive data from another apparatus via one or more wavelengths via an optical link that transmits and receives multiple wavelengths of light; and
determine characteristics of the data based upon the one or more wavelengths of light over the optical link on which the data was received;
a data processing module, communicatively coupled with the one or more computer processors, wherein the data processing module is to process the received data based upon the determined characteristics of the data.

12. The apparatus of claim 11, wherein the characteristics of the data include a selected one of: a quality of service for the data, a priority for the data, or an identification of one or more storage devices for the data.

13. The apparatus of claim 11, wherein the data processing module is communicatively coupled with one or more storage devices, wherein the one or more storage devices are associated with one or more wavelengths of light of the optical link.

14. The apparatus of claim 12, wherein the data is processed at a responsiveness level based upon the quality of service for the data.

15. The apparatus of claim 14, wherein the responsiveness level is associated with a minimum bandwidth value or a maximum latency value.

16. The apparatus of claim 11, wherein the other apparatus further comprises multiple other apparatuses; and wherein the optical link includes multiple optical links.

17. The apparatus of claim 11, wherein the apparatus is a storage endpoint device.

18. The apparatus of claim 11, wherein the apparatus is at least partially implemented with an application-specific integrated circuit (ASIC) or a field programmable gate array (FPGA).

19. A method comprising:
identifying, by a first device, data to be sent to a second device via an optical link that transmits wavelengths of light;
determining, by the first device, characteristics of the data to be sent to the second device;
identifying, by the first device, based upon the determined characteristics of the data, one or more wavelengths of light on which the data is to be transmitted;
transmitting, by the first device to the second device over the optical link, the identified data on the one or more wavelengths of light;
receiving, by the second device, the data over the optical link on the one or more wavelengths of light;
identifying, by the second device, characteristics of the data based upon the one or more wavelengths of light on which the data was transmitted.

20. The method of claim 19, further including processing, by the second device, the received data based upon the identified characteristics of the data.

21. The method of claim 20, wherein characteristics of the data identify a class of service for the data or identify one or more storage devices coupled with the second device associated with the data.

22. A system, comprising:
an optical link;
a first device coupled with the optical link, the first device to:
identify data to be sent to a second device via an optical link that transmits wavelengths of light;
determine characteristics of the data to be sent to the second device;
identify, based upon the determined characteristics of the data, one or more wavelengths of light on which the data is to be transmitted to the second device; and
transmit the identified data to the second device over the optical link using the one or more wavelengths of light, wherein the second device, upon receipt of the data, is to identify the characteristics of the data based upon the one or more wavelengths of light over which the data was transmitted;
the second device coupled to the optical link, the second device to:
receive data from the first device via the one or more wavelengths via the optical link;
determine characteristics of the received data based upon the one or more wavelengths of light; and
the received data based upon the determined characteristics of the received data.

23. The system of claim 22, further comprising:
a plurality of storage devices coupled with the second device; and
wherein to process the received data further includes: to read and/or write data related to the received data from and/or to one or more of the plurality of storage devices based on the determined characteristics of the received data.

24. The system of claim 23, wherein the determined characteristics of the received data includes an indication of a quality of service for the received data.

25. The system of claim 24, wherein the indication of the quality of service further includes an indication of a minimum bandwidth value and/or a maximum latency time for reading and/or writing data.
